(19) United States
(12) Patent Application Publication
(10) Pub. No.: US 2022/0163193 A1
(43) Pub. Date: May 26, 2022

(54) METHOD FOR REALISING AN LED DIMMING ASSEMBLY AND AN LED DIMMING ASSEMBLY

(71) Applicant: KLEMKO TECHNIEK B.V., SOEST (NL)

(72) Inventors: Adrianus Jacobus KLAVER, SOEST (NL); Petrus VAN ROSSUM, SOEST (NL)

(73) Assignee: KLEMKO TECHNIEK B.V., SOEST (NL)

(21) Appl. No.: 17/440,628

(22) PCT Filed: Jan. 16, 2020
(86) PCT No.: PCT/NL2020/050021

§ 371 Date: Sep. 17, 2021

(30) Foreign Application Priority Data
Mar. 20, 2019 (NL) 2022773

(51) Int. Cl. F21V 23/00; H05B 45/10; F21V 23/04

(52) U.S. Cl. CPC F21V 23/008; F21Y 2115/10; F21V 23/04; H05B 45/10

(57) ABSTRACT

Method for realising an LED dimming assembly comprising the steps of providing a dimming unit arranged, providing a holder, positioning said dimming unit in said holder, providing a front plate arranged for connecting to said holder and connecting said front plate to said holder. An LED dimming assembly comprising the dimming unit, holder and front plate.

According to a first aspect the present disclosure relates to a method for realising a Light Emitting Diode, LED, dimming assembly arranged for being provided in, and connected to, a flush-mounted wall installation box of a building wiring system.

According to a second aspect the present disclosure relates to a Light Emitting Diode, LED, dimming assembly arranged for being provided in, and connected to, a flush-mounted wall installation box of a building wiring system.

The method according to the first aspect comprises the steps of:
providing a dimming unit arranged for dimming of an LED based lighting device;
providing a holder comprising a receiving space for removably receiving said dimming unit;
positioning said dimming unit in said receiving space;
providing a front plate arranged for connecting to said holder such that said dimming unit is locked in said receiving space by said holder and said front plate;
connecting said front plate to said holder such that said dimming unit is locked in said receiving space by said holder and said front plate.

The present disclosure relies at least partly on the insight that by positioning the dimming unit in the receiving space and connecting said front plate to said holder for locking said dimming unit in said receiving space the need for providing the dimming unit with connecting means for attachment to a front plate or alternatively providing the dimming unit with a front plate that is integrally formed with the dimming unit is avoided. This is beneficial for using a relative broad range of commercially available dimming units that may not be specifically arranged for being connected to a front plate or directly to a flush-mounted wall installation box.

Moreover, by foregoing the need of providing connecting means for attachment to a front plate or alternatively providing the dimming unit with a front plate that is integrally formed with the dimming unit is beneficial to avoid, or at least significantly reduce, apart from outer dimensions allowing said dimming unit to be received in the receiving space, design constrains on the dimming unit.

Within the context of the present disclosure a building wiring system is to be understood as an electrical installation of cabling and associated devices such as switches, sockets and light fittings in a building such as a home, a utility building or a commercial building. Such building wiring system is subject to standards for design and installation. These standards may be related to formal standardization such as international and/or national standards such a NEN 1020:2018 and NEN-EN-IEC 60670-1:2005. Alternatively, these standards may relate to informal standardization that may result from either informal or formal agreement between suppliers of elements of building wiring systems. Associated devices such a wall installation boxes, preferably flush-mounted wall installation boxes, are subject to functional specifications, such as dimensions, that may vary by locality, country or region.

A flush-mounted wall installation box, or flush-mounted socket, is arranged for being provided in a hole of a wall. The flush-mounted wall installation box may be provided with ribs on the outside of the flush-mounted wall installation box for supporting themselves in the hold of the wall. The flush-mounted wall installation box may be provided with openings that may couple to wiring tubes for receiving electrical wiring via said wiring tubes and coupling a device, such as the dimming assembly according to the present disclosure, provided in the receiving space of the flush-mounted wall installation box to an Alternating Current, AC, mains signal and a further device such as an LED lamp. By providing the wall installation box sufficiently far into the wall, the wall installation box may be flush-mounted as regards the wall surface either directly or after plastering the wall.

Within the context of the present disclosure a dimming unit may be understood as a unit arranged for dimming a Light Emitting Diode, LED, based lighting device to change and/or maintain the brightness of said LED at a brightness level.

Preferably, said holder is arranged for being received inside said flush-mounted wall installation box. This is beneficial for realising a mounting of the holder, preferably mounting of the dimming assembly, that is substantially flush, preferably flush, with a wall surface of a wall comprising said flush-mounted wall installation box either directly or after plastering the wall.

Preferably, said holder comprises a receiving opening for allowing said dimming unit to be provided, via said receiving opening, in said receiving space, wherein during said step of positioning, said dimming unit is positioned, via said receiving opening, in said receiving space, and wherein during said step of connecting, said selected front plate is connected to a wall of said holder surrounding said receiving opening such that said dimming unit is locked in said receiving space by said holder and said front plate. This is beneficial for realising a relative robust holder that may be provided as a single piece without the need for providing a divisible holder comprising at least two housing parts that may be separated for receiving said dimming unit in said receiving space.

Preferably, during said step of connecting, said front plate is directly connected and/or coupled to said holder. This is beneficial for avoiding the need for providing further elements for connecting and/or coupling the front plate to the holder.

It will be understood that when the front plate is referred to as being “connected” or “coupled” to the holder, it can be directly connected or coupled to the holder or intervening elements may be present. In contrast, when the front plate is referred to as being “directly connected” or “directly coupled” to the holder, there are no intervening elements present.

It is beneficial if said holder is provided with an opening for allowing a wire connecting said dimming unit to said LED based lighting device to enter said receiving space. This is beneficial for realising a relative robust holder that may be provided as a single piece.

In a practical embodiment, said dimming unit comprises an operating element for allowing a user to manually set a dimming level, preferably wherein said dimming unit is attached to said front plate via said operating element. This is beneficial for maintaining said dimming unit in a position relative to said holder and said front plate. Maintaining said dimming unit in said position is beneficial for avoiding, or at least significantly reducing the risk, of damaging the dimming unit due to collisions with said holder and/or said front plate.

Preferably, said method comprises the step of:
providing said front plate with a fastening arrangement arranged for fastening said LED dimming assembly to said flush-mounted wall installation box.

Providing the fastening arrangement is beneficial for maintaining said LED dimming assembly in an assembled position relative to said wall installation box. Maintaining said LED dimming assembly in said assembled position is beneficial for avoiding, or at least significantly reducing the risk, of damaging the LED dimming assembly due to collisions with said holder and/or said front plate.

It is beneficial if during said step of providing said front plate, different front plates are provided, wherein said different front plates are arranged for connecting to said holder, wherein said different front plates are arranged for being mounted to different flush-mounted wall installation boxes, said method further comprising the steps of:
providing a geographic location of application of said LED dimming assembly;
determining, based on said geographic location, a connect characteristic of said flush-mounted wall installation box;
selecting a front plate from said provided different front plates taking into account said determined connect characteristic.

Providing a geographical location, determining a connect characteristic and selecting a front plate is beneficial for avoiding the need for maintaining stock of LED dimming assemblies that are configured for a specific geographical location. The connect characteristic may for instance correspond to flush-mounted wall installation boxes of predetermined manufacturers of said wall installation boxes that have a relative large market share at said geographical location.

In this regard it is beneficial if during said step of determining said connect characteristic is determined taking into account a standard applicable for said geographical location. This is beneficial for realising an LED dimming assembly that may be used with a relative large number of flush-mounted wall installation boxes at said geographic location.

Preferably, said method further comprises the steps of:
providing said flush-mounted wall installation box;
positioning said LED dimming assembly inside said flush-mounted wall installation box and connecting said LED dimming assembly to said flush-mounted wall installation box.

Preferably, the dimming unit comprises:
a switch arranged for receiving an Alternating Current, AC, mains signal and for providing a supply signal to said LED based lighting device based on a switch control signal;
a controller arranged for providing said switch control signal, and comprising a lookup table comprising a relationship between a current range of a preconfigured LED based lighting device and a brightness range of said preconfigured LED based lighting device;
a dimmer arranged for providing a dimming level to said controller based on an input dimming range;

wherein said controller is further arranged for translating said dimming level to said switch control signal such that said brightness range is linear to said input dimming range using said lookup table.

Preferably dimensions of the receiving space correspond to outer dimensions of the dimming unit such that the dimming unit may be clamped in said holder.

The LED dimming assembly according to the second aspect of the present disclosure comprises:
a dimming unit arranged for dimming of an LED based lighting device;
a holder comprising a receiving space, wherein said dimming unit is removably received in said receiving space;
a front plate releasably connected to said holder such that said dimming unit is locked in said receiving space by said holder and said front plate, wherein said front plate is arranged for being connected to said flush-mounted wall installation box.

Embodiments of the LED dimming assembly correspond to embodiments of the method according to the first aspect of the present disclosure. The advantages of the LED dimming assembly correspond to advantages of the method according to first aspect of the present disclosure presented previously.

Preferably, said holder is arranged for being received inside said flush-mounted wall installation box. This is beneficial for realising a mounting of the holder, preferably mounting of the dimming assembly, that is substantially flush, preferably flush, with a wall surface of a wall comprising said flush-mounted wall installation box either directly or after plastering the wall.

Preferably, said front plate is directly connected and/or coupled to said holder. This is beneficial for avoiding the need for providing further elements for connecting and/or coupling the front plate to the holder.

Preferably, said holder comprises a receiving opening for allowing said dimming unit to be provided, via said receiving opening, in said receiving space, wherein said front plate is releasably connected to a wall of said holder surrounding said receiving opening. This is beneficial for realising a relative robust holder that may be provided as a single piece without the need for providing a divisible holder comprising at least two housing parts that may be separated for receiving said dimming unit in said receiving space.

It is beneficial if said front plate is chosen from a selection of front plates, wherein each of said front plates of said selection of front plates is arranged for connection to different flush-mounted wall installation boxes. This is beneficial for reducing the need for maintaining stock of LED dimming assemblies that are configured for different flush-mounted wall installation boxes.

In this regard it is beneficial that said front plate is arranged for connection to said flush-mounted wall installation box meeting a standard for a geographical location. This is beneficial for realising an LED dimming assembly that may be used with a relative large number of flush-mounted wall installation boxes at said geographic location.

Preferably, said holder is provided with an opening for allowing a wire connecting said dimming unit to said LED based lighting device to enter said receiving space.

It is advantageous if said dimming unit comprises an operating element for allowing a user to manually set a dimming level, preferably wherein said dimming unit is attached to said front plate via said operating element. This is beneficial for maintaining said dimming unit in a position relative to said holder and said front plate. Maintaining said dimming unit in said position is beneficial for avoiding, or at least significantly reducing the risk, of damaging the dimming unit due to collisions with said holder and/or said front plate.

In an embodiment of said LED dimming assembly, said front plate is provided with a fastening arrangement arranged for fastening said LED dimming assembly to said flush-mounted wall installation box. Providing the fastening arrangement is beneficial for maintaining said LED dimming assembly in an assembled position relative to said wall installation box. Maintaining said LED dimming assembly in said assembled position is beneficial for avoiding, or at least significantly reducing the risk, of damaging the LED dimming assembly due to collisions with said holder and/or said front plate.

Preferably, the dimming unit comprises:
a switch arranged for receiving an Alternating Current, AC, mains signal and for providing a supply signal to said LED based lighting device based on a switch control signal;
a controller arranged for providing said switch control signal, and comprising a lookup table comprising a relationship between a current range of a preconfigured LED based lighting device and a brightness range of said preconfigured LED based lighting device;
a dimmer arranged for providing a dimming level to said controller based on an input dimming range;

wherein said controller is further arranged for translating said dimming level to said switch control signal such that said brightness range is linear to said input dimming range using said lookup table.

According to a third aspect the present disclosure relates to a method for realising a Light Emitting Diode, LED, dimming assembly arranged for being provided in, and connected to, a wall installation box of a building wiring system, said method comprising the steps of:
providing a dimming unit arranged for dimming of an LED based lighting device;
providing a holder comprising a receiving space for removably receiving said dimming unit and a receiving opening for allowing said dimming unit to be provided, via said receiving opening, in said receiving space;
positioning said dimming unit, via said receiving opening, in said receiving space;
providing a front plate arranged for connecting to said holder such that said dimming unit is locked in said receiving space by said holder and said front plate;
connecting said front plate to a wall of said holder surrounding said receiving opening such that said dimming unit is locked in said receiving space by said holder and said front plate.

Embodiments of the method according to the third aspect correspond to embodiments of the method according to the first aspect of the present disclosure.

The advantages of the method according to the third aspect correspond to advantages of the method according to first aspect of the present disclosure presented previously.

According to a fourth aspect the present disclosure relates to a Light Emitting Diode, LED, dimming assembly arranged for being provided in, and connected to, a wall installation box of a building wiring system, said LED dimming assembly comprising:
a dimming unit arranged for dimming of an LED based lighting device;
a holder comprising a receiving space and a receiving opening for allowing said dimming unit to be provided, via said receiving opening, in said receiving space, wherein said dimming unit is removably received in said receiving space;
a front plate releasably connected to a wall of said holder surrounding said receiving opening such that said dimming unit is locked in said receiving space by said holder and said front plate, wherein said front plate is arranged for being connected to said wall installation box.

Embodiments of the LED dimming assembly according to the fourth aspect correspond to embodiments of the LED dimming assembly according to the second aspect of the present disclosure. The advantages of the LED dimming assembly according to the fourth aspect correspond to advantages of the LED dimming assembly according to second aspect of the present disclosure presented previously.

The present invention will now be explained by means of a description of method according to the first aspect of the present disclosure and an LED dimming assembly according to the second aspect of the present disclosure, in which reference is made to the following schematic figures, in which:

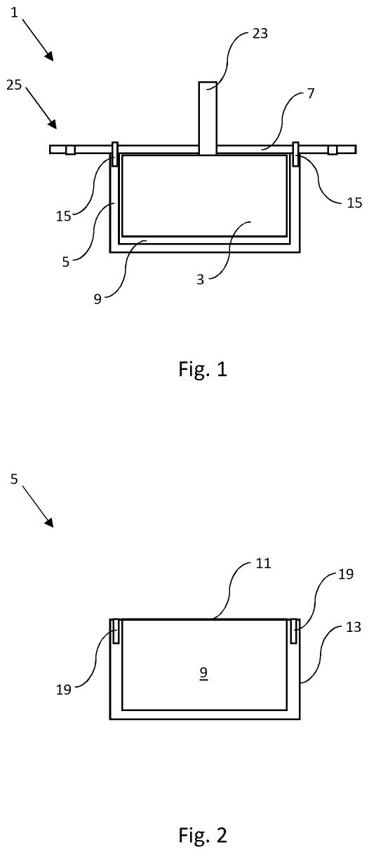

FIG. 1: an LED dimming assembly according to the second aspect is shown;

FIG. 2: an element of an LED dimming assembly according to the second aspect is shown;

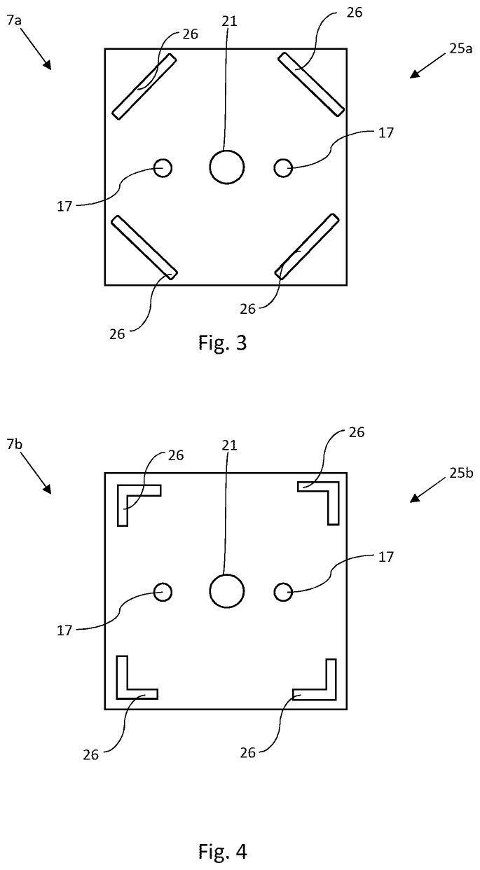

FIG. 3: a further element of an LED dimming assembly according to the second aspect is shown;

FIG. 4: a yet further element of an LED dimming assembly according to the second aspect is shown;

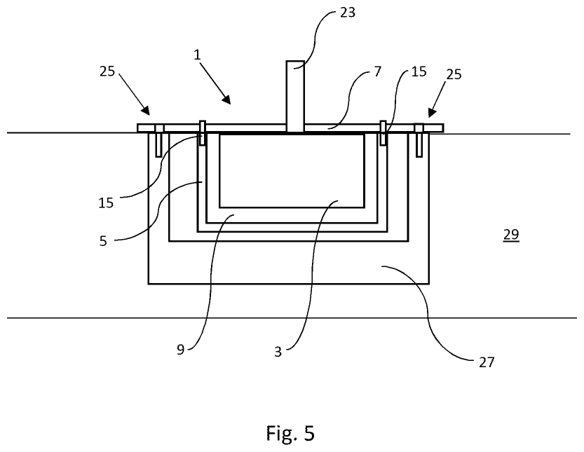

FIG. 5: an assembly of an LED dimming assembly according to the second aspect and a flush-mounted wall installation box is shown;

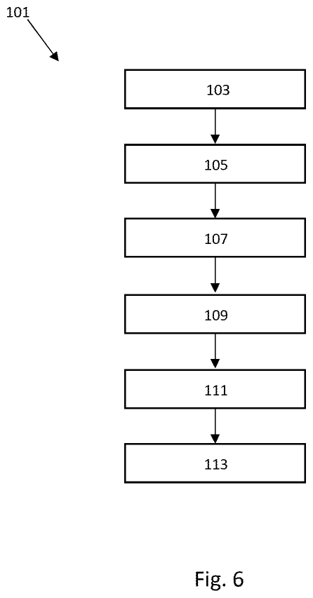

FIG. 6: a method according to the first aspect is shown;

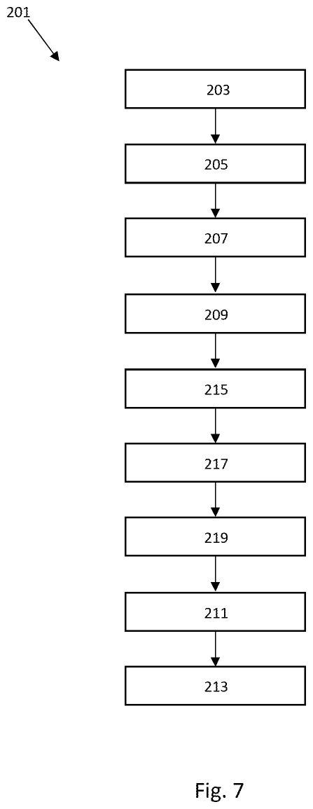

FIG. 7: a further method according to the first aspect is shown;

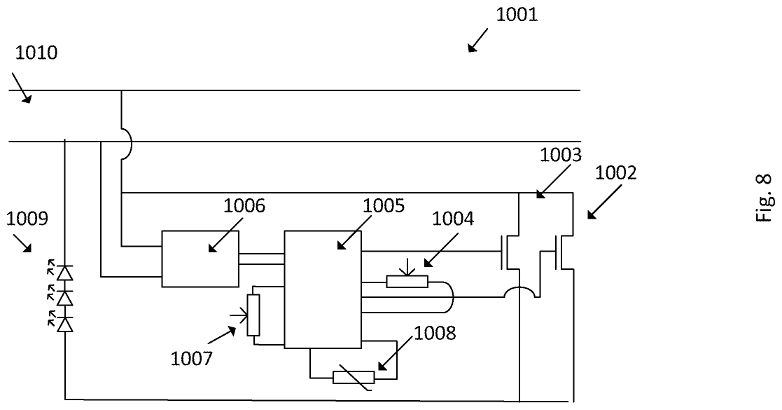

FIG. 8: a schematic diagram of an electric circuit illustrating components comprised by the dimming unit;

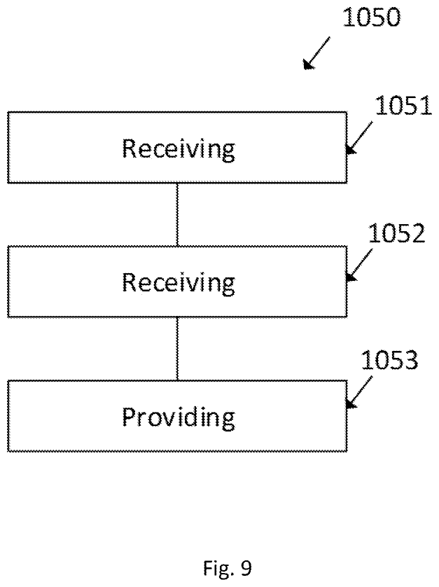

FIG. 9: discloses a schematic flow diagram of a method of operating the dimming unit from FIG. 8.

Light Emitting Diode, LED, dimming assembly 1 comprises a dimming unit 3, a holder 5 and a front plate 7. The holder 5 comprises a receiving space 9 and a receiving opening 11 for receiving said dimming unit 3, via said receiving opening 11 in said receiving space 9. For allowing said dimming unit 3 to be received via said receiving opening 11 in said receiving space 9, dimensions of said receiving opening 11 and said receiving space 9 are larger than outer dimensions of said dimming unit 3. In an embodiment dimensions of the receiving space correspond to outer dimensions of the dimming unit such that the dimming unit may be clamped in said holder. The dimming unit 3 is removably received in said receiving space 9 and may be removed, via said receiving opening 11, from said receiving space 9. The holder 5 comprises a polymer and may be manufactured by injection moulding. The outer dimensions of the holder 5 are such that the holder 5 may be received in a flush-mounted wall installation box of a home wiring system. The holder 5 is further provided with an opening (not shown) for allowing a wire connecting said dimming unit 3 to said LED lamp (not shown) to enter said receiving space 9.

The dimming unit 3 is locked in said receiving space 9 by connecting said front plate 7 to said holder 5. The front plate 7 is releasably connected to a wall 13 of said holder 5 using fastening organs 15 such as screws. The screws 15 are provided in through holes 17 of said front plate 7, wherein said screws 15 cooperate with a screw thread (not shown) provided in a wall surrounding screw holes 19 provided in said holder 5. The front plate 7 is further provided with an operating opening 21 that is arranged for allowing an operating element 23 of said dimming unit 3 to pass through said front plate 7. The front plate 7 further comprises a fastening arrangement 25 that is arranged for fastening said LED dimming assembly 1 to a flush-mounted wall installation box 27 provided in a wall 29.

The LED dimming assembly 1 may be provided with different front plates 7a, 7b. The different front plates 7a, 7b are identical as regards the provision of the through holes 17 and the operating opening 21 but differ as regards the fastening arrangement 25a, 25b. The fastening arrangements 25, 25a, 25b are comprises openings 26 that are arranged for connection to different flush-mounted wall installation boxes meeting a standard for a geographical location.

FIG. 8 discloses a schematic diagram 1001 of an electric circuit illustrating components comprised by the dimming unit 3. In accordance with the present disclosure, the dimming unit 3 may comprise a plurality of components.

In this particular example, the dimming unit 3 comprises two switches as indicated with reference numerals 1002 and 1003. A first 1002 of the switches is arranged for allowing a positive half of the received Alternating Current, AC, mains signal to pass to the LED based lighting device 1009, and a second 1003 of the switches is arranged for allowing a negative half of the received AC mains signal to pass to the LED based lighting device 1009. The switches are controlled based on a switch control signals, which switch control signals are fed to the gates of the switches.

In this particular scenario, the switches 1002, 1003 are power Metal Oxide Semiconductor, MOS, Field Effect Transistors, FETS. It may be noted that the switches may also comprise transistors, relays, or anything alike.

A controller 1005 is provided in the form of a block. The controller 1005 may, for example, be an Integrated Controller, IC, an Application Specific IC, ASIC, a Field Programmable Gate Array, FPGA, analogue electronica, or anything alike.

The controller 1005 comprises a lookup table comprising a relationship between a current range of a preconfigured LED based lighting device 1009 and a brightness range of said preconfigured LED based lighting device 1009. The lookup table may thus comprises a particular brightness, for example Lumen, for a particular current that flows through the LED based lighting device 1009.

The dimming unit 3 may further comprise a dimmer 1004 arranged for providing a dimming level to said controller 1005 based on an input dimming range. The dimmer 1004 is, for example, a potentiometer. The potentiometer has a sliding or rotating contact which the user is able to manipulate to select the desired dimming range.

The controller 1005 is arranged for translating said dimming level to said switch control signal such that said brightness range is linear to said input dimming range using said lookup table. The end result is thus that the user perceives as if the brightness that originates from the LED based lighting device 1009 is linearly depending on the input dimming range.

The switch control signals, provided by the controller 1005, may be a PWM signal, i.e. a Pulse Width Modulation, signal. The PWM signal to the first switch may be inverted compared to the PWM signal to the second switch.

Further, a power unit 1006 is provided for converting the AC mains supply 1010 a low voltage power for empowering the controller 1005. The power unit 1006 may comprise a switched power supply or a transformer or anything alike.

It is noted that the controller may further be arranged for measuring a current of said supply signal to said LED based lighting device and/or wherein said controller is arranged for calibrating said translating by measuring said current of said supply signal over said full input dimming range. The current flowing to the LED based lighting device 1009 may be measured using a low Ohmic resistor in the current path to the LED based lighting device.

The dimming unit 3 may further comprise a minimum threshold setter 1007, for example also a potentiometer, for setting a minimum threshold of said dimming level of said dimmer.

Finally, a safety mechanism may be provided in the form of a Negative Temperature Coefficient, NTC, resistor 1008. The resistor may indicate to the controller 1005 if the temperature rises too high. That particular input may be used by the controller to shut things down, or to take other adequate measures.

Method 101 comprises the step 103 of providing the dimming unit 3 and the step 105 of providing the holder 5. During step 107 of the method 101, said dimming unit 3 is positioned, via said receiving opening 11, in said receiving space 9.

Method 101 further comprises the step 109 of providing the front plate 5. Step 109 may be executed before or after said step 107. After said step 107 and said step 109, said front plate 7 is connected to said holder 5 during a step 111 such that said dimming unit 3 is locked in said receiving space 9 by said holder 5 and said front plate 7. Optionally, method 101 may comprise step 113 during which said dimming unit 3 is attached to said front plate 7 via said operating element 23.

Method 201 differs mainly from method 101 in that during said step 209 of providing different front plates 7, 7a, 7b are provided, and in that method 201 further comprises a step 215 of providing a geographic location of application of said LED dimming assembly 1, a step 217 of determining, based on said geographic location, a connect characteristic of said flush-mounted wall installation box 27 and a step 219 of selecting a front plate 7, 7a, 7b from said provided different front plates 7, 7a, 7b taking into account said determined connect characteristic. A step of method 201 corresponding to a step of method 101 is provided with a reference numeral of the step of method 101 increased by 100.

FIG. 9 discloses a schematic flow diagram of a method 1050 of operating a dimming unit 3. The method 1050 is directed to operating a dimming unit in accordance with any of the examples as provided above, wherein said method comprises the steps of:
receiving 1051, by said switch, said AC mains signals and providing said supply signal to said LED based lighting device based on said switch control signal;
receiving 1052, by said controller, from said dimmer, said dimming level based on said input dimming range;
providing 1053, by said controller, said switch control signal to said switch by translating said dimming level to said switch control signal such that said brightness range is linear to said input dimming range using said lookup table.

1-15. (canceled)

16. A method for installing a Light Emitting Diode (LED) dimming assembly into a flush-mounted wall installation box of a building wiring system, the method comprising the steps of:
providing a dimming unit configured to dim an LED based lighting device;
providing a holder comprising a receiving space for removably receiving the dimming unit and a receiving opening for allowing the dimming unit to be provided, via the receiving opening, in the receiving space, wherein the holder is configured for being received inside the flush-mounted wall installation box;
positioning the dimming unit, via the receiving opening, in the receiving space;
providing a front plate for connecting to the holder such that the dimming unit is locked in the receiving space by the holder and the front plate; and
connecting the front plate to a wall of the holder surrounding the receiving opening such that the dimming unit is locked in the receiving space by the holder and the front plate.

17. The method according to claim 16, wherein the holder includes an opening for allowing a wire connecting the dimming unit to the LED based lighting device to enter the receiving space.

18. The method according to claim 16, wherein the dimming unit comprises an operating element for allowing a user to manually set a dimming level, wherein the dimming unit is attached to the front plate via the operating element.

19. The method according to claim 16, further comprising the step of:
providing the front plate with a fastening arrangement for fastening the LED dimming assembly to the flush-mounted wall installation box.

20. The method according to claim 16, wherein, during the step of providing the front plate, different front plates are provided, wherein the different front plates are configured for connecting to the holder, wherein the different front plates are configured for being mounted to different flush-mounted wall installation boxes, the method further comprising the steps of:
providing a geographic location of application of the LED dimming assembly;
determining, based on the provided geographic location, a connect characteristic of the flush-mounted wall installation box; and
selecting a front plate from the provided different front plates according to the determined connect characteristic.

21. The method according to claim 20, wherein the step of determining the connect characteristic is according to a standard applicable for the geographical location.

22. The method according to claim 16, further comprising the steps of:
providing the flush-mounted wall installation box;
positioning the LED dimming assembly inside the flush-mounted wall installation box; and
connecting the LED dimming assembly to the flush-mounted wall installation box.

23. The method according to claim 16, wherein the dimming unit comprises:
a switch configured to receive an Alternating Current (AC) main signal and provide a supply signal to the LED based lighting device based on a switch control signal;
a controller configured to provide the switch control signal, and comprising a lookup table comprising a relationship between a current range of a preconfigured LED based lighting device and a brightness range of the preconfigured LED based lighting device; and
a dimmer configured to provide a dimming level to the controller based on an input dimming range;
wherein the controller is further configured to translate the dimming level to the switch control signal such that the brightness range is linear to the input dimming range using said lookup table.

24. A Light Emitting Diode (LED) dimming assembly configured to be provided in, and connected to, a flush-mounted wall installation box of a building wiring system, the LED dimming assembly comprising:
a dimming unit configured to dim an LED based lighting device;
a holder comprising a receiving space and a receiving opening for allowing the dimming unit to be provided, via the receiving opening, in the receiving space, wherein the dimming unit is removably received in the receiving space and wherein the holder is configured to be received inside the flush-mounted wall installation box; and
a front plate releasably connected to a wall of the holder surrounding the receiving opening such that the dimming unit is locked in the receiving space by the holder and the front plate, wherein the front plate is configured to be connected to the flush-mounted wall installation box.

25. The LED dimming assembly according to claim 24, wherein the front plate is selected from a plurality of different front plates, wherein each of the different front plates is configured for connection to a different one of a plurality of flush-mounted wall installation boxes.

26. The LED dimming assembly according to claim 24, wherein the front plate is configured for connection to the flush-mounted wall installation box meeting a standard for a geographical location.

27. The LED dimming assembly according to claim 24, wherein the holder includes an opening for allowing a wire connecting the dimming unit to the LED based lighting device to enter the receiving space.

28. The LED dimming assembly according to claim 24, wherein the dimming unit comprises an operating element for allowing a user to manually set a dimming level, wherein the dimming unit is attached to the front plate via the operating element.

29. The LED dimming assembly according to claim 24, wherein the front plate includes a fastening arrangement for fastening the LED dimming assembly to the flush-mounted wall installation box.

30. The LED dimming assembly according to claim 24, wherein the dimming unit comprises:
a switch configured to receive an Alternating Current (AC) main signal and provide a supply signal to the LED based lighting device based on a switch control signal;
a controller configured to provide the switch control signal, and comprising a lookup table comprising a relationship between a current range of a preconfigured LED based lighting device and a brightness range of the preconfigured LED based lighting device; and
a dimmer configured to provide a dimming level to the controller based on an input dimming range;
wherein the controller is further configured to translate the dimming level to the switch control signal such that the brightness range is linear to the input dimming range using the lookup table.
